(19) United States
(12) Patent Application Publication
(10) Pub. No.: US 2024/0167310 A1
(43) Pub. Date: May 23, 2024

(54) METHOD FOR OPERATING A MOTORIZED FLAP ARRANGEMENT OF A MOTOR VEHICLE

(71) Applicant: Brose Fahrzeugteile GmbH SE & Co. Kommanditgesellschaft, Bamberg, Bamberg (DE)

(72) Inventor: Sebastian Schoedel, Eckersdorf (DE)

(21) Appl. No.: 18/516,672

(22) Filed: Nov. 21, 2023

(30) Foreign Application Priority Data
Nov. 21, 2022 (DE) 10 2022 130 711.5

(51) Int. Cl. E05F 15/73

(52) U.S. Cl. CPC E05F 15/73; E05F 2015/765; E05Y 2400/858; E05Y 2900/50

(57) ABSTRACT

A method for operating a flap arrangement is provided, a drive arrangement having at least one drive, a sensor arrangement and a control arrangement coupled to the drive arrangement and to the sensor arrangement, sensor values relating to an operator action performed by an operator outside of the motor vehicle being sensed by the sensor arrangement, the sensed sensor values being checked by the control arrangement in a check routine for the presence of a valid operator action, and the drive arrangement being caused by the control arrangement to effect a motorized adjustment. A predefined selection of characteristic values can be determined from the sensor values in the check routine, a recognition value of the operator action can be calculated from the determined characteristic values using a predefined weighting function with respective weighting parameters, and the operator action can be classified as a valid operator action.

### CLAIM OF PRIORITY

This application claims the benefit of German Patent application No. DE 10 2022 130 711.5 filed on Nov. 21, 2022, the disclosure of which is incorporated herein by reference.

### FIELD OF THE TECHNOLOGY

Various embodiments relate to a method for operating a motorized flap arrangement of a motor vehicle, to a control arrangement for a motorized flap arrangement of a motor vehicle, and to a flap arrangement for a motor vehicle.

### BACKGROUND

The known prior art (DE 10 2017 129 151 A1) on which the some embodiments are based provides for operation of the flap via a predefined operator action, which may be a foot movement performed by the operator. An actuation sensed as a valid operator action causes the motorized flap arrangement to be operated, such that the operator can open or close the flap, in particular contactlessly.

For greater convenience, the sensing of validly executed operator actions is to be guaranteed with a high degree of reliability, while at the same time unwanted triggering of the motorized adjustment by movements incorrectly qualified as valid operator actions is to be prevented.

In the case of the known method (DE 10 2017 129 151 A1), on which some embodiments are based, an operator action is sensed by a sensor arrangement using sensor values, a valid operator action being based on permitted ranges of sensor values or values derived therefrom. A prerequisite for qualification as a valid operator action may be that all relevant values lie within the permitted ranges, with the linking of a plurality of necessary conditions being provided in order to prevent mis-triggering.

### SUMMARY

A challenge here is that powerful sensor arrangements such as, for example, radar sensors provide a multiplicity of sensor values that allow detailed sensing of the operator action. However, defining the permitted ranges for respective sensor values, in order to reliably recognize a valid operator action, is comparatively complex.

Various embodiments are based on the object of designing and developing the known method so as to enhance, in a simple manner, the reliability of recognition of the operator action for triggering the motorized adjustment.

The above object is achieved by various features described herein.

The flap arrangement in question has a motor-adjustable flap. The flap may be any closure element of a motor vehicle. These include tailgates, trunk covers, front hoods, in particular engine hoods, doors, in particular side or rear doors, or the like. The flap may be arranged in a pivotable or longitudinally displaceable manner on the vehicle body.

Here, sensor values sensed by a sensor arrangement that is designed, in particular, as a radar sensor are checked in a check routine, by means of a control arrangement, for the presence of a valid operator action. The fundamental consideration is to determine, from the time-dependent sensor values, individual characteristic values that are weighted with weighting parameters and combined to form a recognition value. Consequently, only a small number of parameters need to be established to check the operator action, in this case for the weighting, and the matching of the recognition value against a recognition criterion can also be performed particularly easily.

In detail, it is proposed that a predefined selection of characteristic values be determined from the sensor values in the check routine, that a recognition value of the operator action be calculated from the determined characteristic values using a predefined weighting function with respective weighting parameters assigned to the characteristic values, and that the operator action be classified as a valid operator action if a recognition criterion is fulfilled by the recognition value.

In various embodiments, the weighting function is predefined as a linear function, thereby enabling the weighting parameters to be established with ease and the calculation of the recognition value to be implemented with particularly little effort.

According to various embodiments, the characteristic values may relate to measured variables, such as distance values and velocity values, that can be taken directly or indirectly from the sensor value. Further, values derived from distance values and velocity values may be used. It can be particularly advantageous to use correlation values from distance values and velocity values, so that inaccuracies in the sensor values, such as inconsistent tracking of radar targets when sensing the operator action, do not lead to mis-triggering.

Various possibilities for selecting the characteristic values, which can be particularly significant in connection with recognition of the operator action, are provided in some embodiments. In some embodiments, statistical characteristic values are determined as characteristic values.

Particular flexibility of the solution according to the proposal for use in different motor vehicles and installation situations is provided by the design according to some embodiments, according to which a machine learning model, such as a support vector machine, is used in addition to the calculation of the recognition value. The machine learning model in this case may reproduce the basic properties of the sensor arrangement, while the weighting parameters primarily represent the individual requirements based on the installation situation. Consequently, for example for use in a different type of vehicle, only an adaptation of the more simply structured weighting parameters is effected.

Accordingly, the weighting parameters may be stored elsewhere in the vehicle, for example in the central motor-vehicle control system, and transmitted to the control system of the flap arrangement for the purpose of individualizing the check routine.

The use of the weighting parameters also simplifies the adaptation of the recognition of the operator gesture to the respective boundary conditions during operation. In various embodiments, different operating modes, having respective weighting parameters, are provided, such that special situations such as a person sitting on the flap arrangement, servicing, a cleaning process or the like can be taken into consideration with a respective set of weighting parameters.

The design according to some embodiments takes up the already mentioned simple parameterization for the check routine, whereby in particular a linear regression for determining the weighting parameters may be performed on the basis of predefined parameterization sensor values.

Some embodiments provide a control arrangement for a motorized flap arrangement of a motor vehicle.

It can be essential here that the control arrangement be configured to determine a predefined selection of characteristic values from the sensor values in the check routine, to calculate a recognition value of the operator action from the determined characteristic values using a predefined weighting function with respective weighting parameters assigned to the characteristic values, and to classify the operator action as a valid operator action if a recognition criterion is fulfilled by the recognition value. Reference may be made to all explanations regarding the method according to the proposal.

Some embodiments provide a flap arrangement for a motor vehicle, the flap arrangement being configured to perform the method according to the proposal. Reference may be made to all the explanations regarding the method according to the proposal and to the control arrangement according to the proposal.

Particularly advantageous can be the solution according to the proposal having a sensor arrangement designed as a radar sensor, as a greatly simplified evaluation of generally comprehensive radar values is made possible.

Various embodiments provide a method for operating a motorized flap arrangement of a motor vehicle, a drive arrangement having at least one drive assigned to a flap, a sensor arrangement and a control arrangement coupled to the drive arrangement and to the sensor arrangement being provided, sensor values relating to an operator action performed by an operator outside of the motor vehicle being sensed by means of the sensor arrangement, the sensed sensor values being checked by means of the control arrangement in a check routine for the presence of a valid operator action, and the drive arrangement being caused by means of the control arrangement to effect a motorized adjustment if a valid operator action is present, wherein a predefined selection of characteristic values is determined from the sensor values in the check routine, a recognition value of the operator action is calculated from the determined characteristic values using a predefined weighting function with respective weighting parameters assigned to the characteristic values, and the operator action is classified as a valid operator action if a recognition criterion is fulfilled by the recognition value.

In various embodiments, the weighting function is predefined as a linear function of the characteristic values with the weighting parameters as coefficients of the characteristic values.

In various embodiments, the predefined selection comprises characteristic values of distance values and/or velocity values from the sensor values, and/or the predefined selection comprises characteristic values of values derived from distance values and velocity values, in some embodiments correlation values, in some embodiments cross-correlation values, from distance values and velocity values.

In various embodiments, the predefined selection comprises characteristic values of intensity values, angle values and/or noise values from the sensor values.

In various embodiments, a check-time window is established from the sensed sensor values by means of the control arrangement on the basis a trigger criterion, and the sensor values sensed in the check time period are subjected to the check routine.

In various embodiments, the characteristic values are redefined as statistical characteristic values. In some embodiments, the characteristic values of the selection comprise at least one of: maximum value, minimum value, time point of maximum value, time point of minimum value, mean value, variance, skewness, and/or kurtosis.

In various embodiments, in the check routine, sensor values are fed as input values to a trained machine learning model, and the recognition criterion relates to an output value of the trained machine learning model in addition to the recognition value. In some embodiments, the trained machine learning model is based on a support vector machine.

In various embodiments, the weighting parameters are obtained by means of the control arrangement via a communication network of the motor vehicle, in particular transmitted from a central motor-vehicle control system. In some embodiments, the trained machine learning model is stored in the control arrangement.

In various embodiments, a plurality of sets of weighting parameters are provided, with an operating mode being assigned to each of them, when one of the operating modes occurs, in particular as a result of an operating-mode criterion being fulfilled by the sensor values and/or as a result of an operating-mode signal being obtained by means of the control arrangement, the set of weighting parameters assigned to the respective operating mode is used in the check routine.

In various embodiments, the weighting parameters are determined in a parameterization routine based on predefined parameterization sensor values in accordance with a parameterization rule, in some embodiments the recognition criterion is defined, at least partly, as a threshold value for the recognition value, and the weighting parameters are determined using a parameterization rule based on linear regression.

Various embodiments provide a control arrangement for a motorized flap arrangement of a motor vehicle, the control arrangement, when in the mounted state, being coupled to a sensor arrangement that senses sensor values relating to an operator action performed by an operator outside of the motor vehicle, the control arrangement checking the sensed sensor values in a check routine for the presence of a valid operator action, and the control arrangement causing a drive arrangement of the flap arrangement to effect a motorized adjustment if a valid operator action is present, wherein the control arrangement is configured to determine a predefined selection of characteristic values from the sensor values in the check routine, to calculate a recognition value of the operator action from the determined characteristic values using a predefined weighting function with respective weighting parameters assigned to the characteristic values, and to classify the operator action as a valid operator action if a recognition criterion is fulfilled by the recognition value.

Various embodiments provide a flap arrangement for a motor vehicle, the flap arrangement being configured to perform the method as described herein.

In various embodiments, the sensor arrangement has at least one radar sensor.

### BRIEF DESCRIPTION OF THE DRAWINGS

Various aspects are explained in greater detail in the following with reference to a drawing, which shows merely exemplary embodiments. In the drawing

FIG. 1 shows a rear region of a motor vehicle having a flap arrangement according to the proposal for performing the method according to the proposal,

FIG. 2 shows a schematic sequence diagram relating to the check routine, and

FIG. 3 shows examples of sensor values in the establishing of a check-time window.

### DETAILED DESCRIPTION

The method according to the proposal relates to the operation of a motorized flap arrangement 1 of a motor vehicle 2. A drive arrangement 3, having at least one drive 5 assigned to a flap 4 of the flap arrangement 1, is provided.

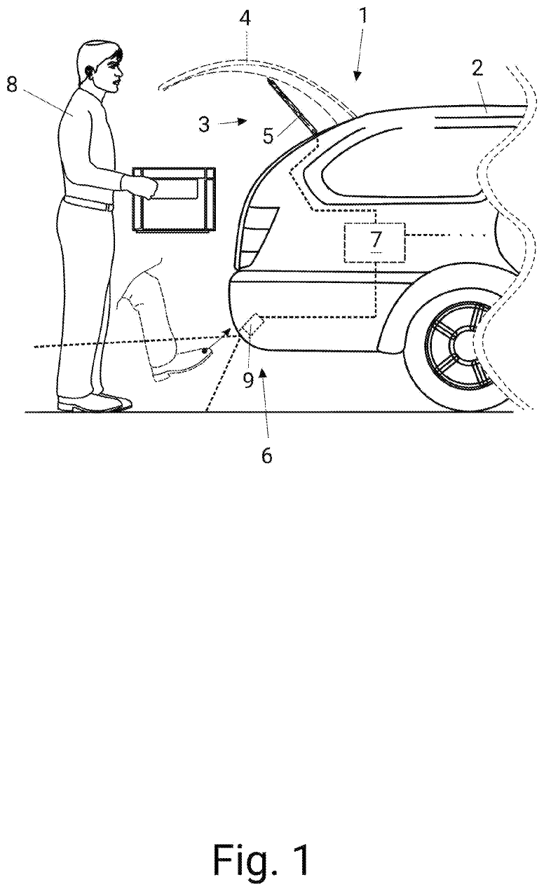

In the case of the represented exemplary embodiment, the drive arrangement 3 is designed to move the flap 4 of the flap arrangement 1 from a closed position to the open position that, in FIG. 1, is indicated by a dashed line. 1. Likewise, the flap 4 may also be moved from an open position to a closed position. In principle, the drive arrangement 3 may also effect other motorized adjustment functions of the flap arrangement 1, for example unlocking and/or opening a motor vehicle lock assigned to the flap 4. Regarding possible designs of the flap 4, reference is made to the introductory remarks, although here the flap 4 according to FIG. 1, is in the form of a tailgate.

A sensor arrangement 6 of the flap arrangement 1 is provided, with sensor values relating to respective objects outside of the motor vehicle 2 being sensed by means of the sensor arrangement 6. Also provided is a control arrangement 7 of the flap arrangement 1 that is coupled to the sensor arrangement 6 and the drive arrangement 3 for the purpose of performing the method. The control arrangement 7 is represented, by way of example in FIG. 1, as a component that is separate from the sensor arrangement 6 and drive arrangement 3 and that, in particular for communication, is coupled to the further components via a bus system of the motor vehicle 2 or the like. In some embodiments, the control arrangement 7 may be at least partially integrated into the sensor arrangement 6 and/or the drive arrangement 3.

Sensor values relating to an operator action performed by an operator 8 outside of the motor vehicle 2 are sensed by means of the sensor arrangement 6. An operator action in this case is generally understood to be a time-dependent action of the operator 8, in particular a movement pattern of a body part of the operator 8 such as an operator gesture, in FIG. 1 a foot movement.

In some embodiments, the sensor arrangement 6 has at least one radar sensor 9 that has an antenna arrangement, not represented in greater detail, that can be designed with one or more antenna arrays. In particular, the antenna arrays are arranged at a predefined angle and position relative to one another in order to enable angular resolution of radar signals. The radar sensor 9 here realizes a continuous, in some embodiments frequency-modulated, distance measurement and direction measurement, for instance as an FMCW radar sensor. The radar sensor 9 can be configured for operation with radar radiation in the frequency band around 24 GHz and/or 77 GHz. In various embodiments, UWB operation of the radar sensor 9 may also be provided, for example in the frequency range of from 3.1 GHz to 10.6 GHz.

The sensor values, in this case the radar values, are generally representative of the position of objects outside of the motor vehicle 2. For example, the sensor values comprise distance information and, in particular, information regarding direction between the sensed object, inter alia the operator 8, and the motor vehicle 2. Further, the sensor values may also comprise velocity information, for example based on Doppler information, of the object.

In a check routine, the sensor values that have been sensed are checked by means of the control arrangement 7 for the presence of a valid operator action. Here, the sensor values are assessed by the control arrangement 7 using a predefined check system, which is explained in greater detail below, to determine whether an action of an object sensed in the sensor values corresponds sufficiently to a specification for a valid operator action. In dependence on the result of the check, the operator action sensed via the sensor values is either rejected as invalid or qualified as a valid operator action.

If a valid operator action is present, the control arrangement 7 causes the drive arrangement 3 to effect a motorized adjustment. In addition to the presence of the valid operator action, the performing of the motorized adjustment may be linked to further conditions, for example to a closed state of the flap arrangement 1 (locked/unlocked) and/or to the recognition of an electronic key. Such conditions may in turn be checked by the control arrangement 7 or by other control components coupled to the flap arrangement 1, such as a door control device or the like. Moreover, the motorized adjustment may be implemented by a drive controller of the drive arrangement 3.

What is essential is that a predefined selection of characteristic values 10 be determined from the sensor values in the check routine, that a recognition value S of the operator action be calculated from the determined characteristic values 10 using a predefined weighting function with the respective weighting parameters 11 assigned to the characteristic values 10, and that the operator action be classified as a valid operator action if the recognition value S fulfills a recognition criterion.

If the recognition criterion is not fulfilled, on the other hand, the sensed operator action is rejected as invalid.

The characteristic values 10 are determined by use of a compilation of a plurality of sensor values sensed in chronological succession. The plurality of sensor values sensed in chronological succession are each combined with the characteristic value 10 to form a characteristic numerical measure of the time dependency using a predefined (mathematical) function. The selection of such characteristic values 10 comprises at least two characteristic values 10, or associated functions. In some embodiments, the selection is composed of at least two and at most ten, or at least five and at most ten, in particular eight characteristic values 10, or associated functions.

A recognition value is calculated from the determined characteristic values 10 using weighting parameters 11. The weighting parameters 11 in this case can form coefficients for weighting the determined characteristic values 10 for the calculation of the recognition value. The recognition value can be a single numerical value, which can further be compared against a recognition threshold as part of the recognition criterion.

Consequently, the characteristic values 10 are used to obtain individual characteristics of the time dependency of the sensor values as numerical values. By use of the weighting parameters 11, these numerical values can be combined to form the recognition value, and in particular only the weighting parameters 11 need to be set to specify the valid operator gesture.

The weighting function may in principle be given by any mathematical function that is dependent on the characteristic values 10 and weighting parameters 11. In a simple design, the weighting function is designed as a power series of the characteristic values 10 with the weighting parameters 11 as coefficients.

It can be the case that the weighting function is predefined as a linear function of the characteristic values 10 with the weighting parameters 11 as (linear) coefficients of the characteristic values 10. This results in a simple parameterization by means of the weighting parameters 11 that, as linear coefficients, predefine the influence of the respective characteristic value 10 upon the recognition value.

The selection of the characteristic values 10 may comprise, in particular, statistical characteristic values 10 relating to numerical measures that are known from the statistics for the characterization of probability distributions and that are applied here to the time sequence of sensor values.

In some embodiments, it is provided that the predefined selection comprises characteristic values 10 of distance values and/or velocity values from the sensor values. Here, the terms “distance value” and/or “velocity value” are to be understood in a broad sense, and relate in general to values associated with the distance and/or velocity of the sensed object. In some embodiments, the valid operator action is in the form of an operator gesture that has a particular distance profile and velocity profile over time. Consequently, the time dependence of the distance and/or velocity characterized by the characteristic values 10 can provide an indication of the extent to which the sensed operator gesture corresponds to a predefined operator gesture.

In some embodiments, it is provided that the predefined selection comprises characteristic values 10 of values, in some embodiments correlation values, derived from distance values and velocity values. “Correlation values” are generally understood to mean values that, through a functional relationship, are dependent both on distance values and on velocity values, for example also a ratio of distance values and velocity values or the like.

In some embodiments, the predefined selection comprises statistical values of cross-correlation values from distance values and velocity values. Normally—due to their fundamental relationship by way of the time derivation—the distance values and the velocity values behave in a particular way in the cross-correlation. However, if there are incorrect distance values and velocity values, this may be recognizable in the cross-correlation values.

In some embodiments, in which the sensor arrangement 6 has at least one radar sensor 9, a target tracking routine is executed using the sensor values, with at least one radar target being identified in the radar values, for example using intensity values, and distance values and velocity values, for instance Doppler values, being determined for the radar target as a function of time. If the target tracking is incorrect, for example if the identification of the radar target briefly “jumps” to another object, this is reflected in the cross-correlation values, as the distance and velocity do not correlate with each other as expected.

Further sensor values that form a basis for the characteristic values 10 are conceivable. In further designs, it is provided that the predefined selection comprises characteristic values 10 of intensity values, angle values and/or noise values from the sensor values.

In the case of radar sensors 9, intensity values are to be understood as a measure of the intensity of the radar waves reflected onto the sensor arrangement 6. In general, the sensor values may include an angular resolution, the angular values indicating a measure of the spatial orientation of the object, for example of the radar target, relative to the sensor arrangement 6. The noise values represent higher-frequency deviations and, in particular, a signal-to-noise ratio in the sensor values.

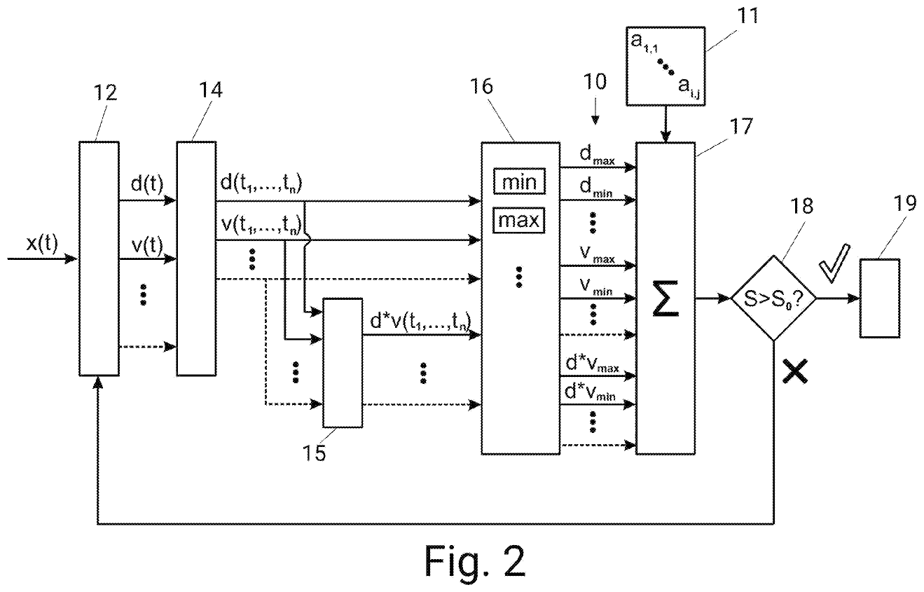

FIG. 2 shows a schematic sequence diagram for the method, the sensor arrangement 6 here having at least one radar sensor 9 that senses radar values as sensor values. In action 12, the target tracking routine already mentioned is first executed, at least one radar target being associated with radar values, in some embodiments on the basis of intensity values. Here, time-dependent distance values d(t) and velocity values v(t) are sensed for the radar target.

Further, it can be provided that a check-time window 13 is established from the sensed sensor values by means of the control arrangement 7 on the basis a trigger criterion, and that the sensor values sensed in the check-time window 13 are subjected to the check routine, this being represented in FIG. 2 as action 14.

The time-dependent distance values d(t) and velocity values v(t) are stored continuously, for example, in a ring buffer. The trigger criterion reflects the fact that there is a time sequence of sensor values for an operator gesture. The establishing the check-time window 13 means that a continuously executed check routine is not absolutely necessary for all sensor values. Instead, the check routine is only executed as required and when the trigger criterion is fulfilled. In the present case, the sensor values (distance values d(t₁, . . . , tₙ) and velocity values v(t₁, . . . , tₙ) to be assigned to the check-time window 13 are fed from the ring buffer to the further check routine.

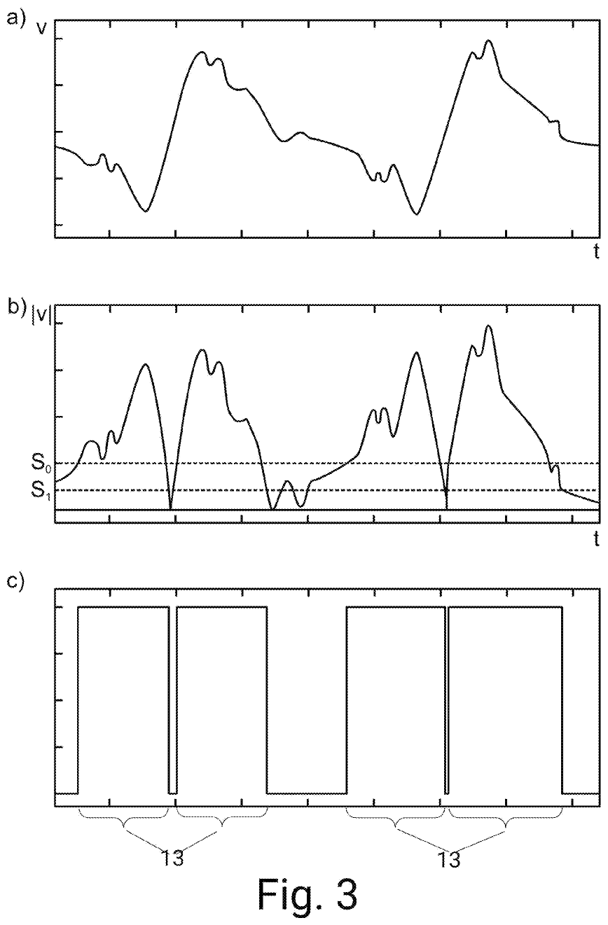

In some embodiments, the trigger criterion comprises a plurality of threshold values that are to be exceeded and/or undershot in a time sequence, for example in the manner of a Schmitt trigger. FIG. 3 shows examples of sensor values in the establishing of a check-time window 13 using the trigger criterion. The sensor values assumed here are the velocity values v(t) shown in FIG. 3a), of which the magnitude |v(t)| shown in FIG. 3b) is checked for the exceeding or undershooting of the threshold values S₁, S₂. Exceeding of the threshold value S₁ establishes the start of the check-time window 13. The end of the check-time window 13 may in turn be established by an undershooting of the threshold value S2, which is different from, in this case lower than, the threshold value S1.

The check-time window 13 does not necessarily have to relate to sensor values that are connected in time. In this case, in FIG. 3, the exceeding of the threshold value S₁ and the subsequent undershooting of the threshold value S₂ by the amount |v(t)| is checked again, and the respective sensor values are also assigned to the check-time window 13. In this case, the first portion of the check time window 13 corresponds, for example, to forward movement of the operator gesture, and the second portion of the check time window 13 corresponds to a retracting movement of the operator gesture. As represented in FIG. 3, the portions may relate to sensor values that are separated in time. For example, sensor values relating to a delay between a forward movement and a retracting movement are not taken into consideration in the check-time window 13, this also being reflected here by the different threshold values. In FIG. 3, the velocity values v(t) show two consecutive, sensed operator actions that result in respective check-time windows 13.

The further check routine is executed for the sensor values in the check-time window 13. In FIG. 2 it is provided that in action 15 further values are determined from the distance values and velocity values by means of a correlation, here by means of a cross-correlation d*v (t₁, . . . , tₙ), for which, in action 16, in addition to the distance values d(t₁, . . . , tₙ) and velocity values v(t₁, . . . , tₙ), respective characteristic values 10 are determined.

As already discussed, different characteristic values 10 may be used. In some embodiments, it is provided that the characteristic values 10 of the selection comprise at least one of: maximum value, minimum value, time point of maximum value, time point of minimum value, mean value, variance, skewness, and/or kurtosis.

Maximum value and minimum value here denote, respectively, the greatest and the least sensor value, for example the least or the greatest distance value, in particular in the check-time window 13. The time point at which the corresponding value occurs may also be used for maximum value and/or minimum value. In particular, the time point is a relative time point since the start of the check-time window 13. Various functions known from statistics for calculating a mean value may be used as the mean value, for example the median, the arithmetic mean value or the like. The same applies to the variance, skewness and kurtosis.

In some embodiments, the selection comprises the aforementioned eight, such as exactly the aforementioned eight characteristic values 10.

For the statistical characteristic values 10, the recognition value S is calculated in action 17 using the weighting function. In some embodiments, the characteristic values 10 are incorporated linearly into the weighting function, with the weighting parameters 11 being provided as linear coefficients for the statistical characteristic values 10.

This results in a particularly simple parameterization for the recognition value S. For example, the selection relates to distance values d, velocity values v and cross-correlation values d*v, for each of which eight characteristic values 10 are determined. This means that just 24, in particular linear, weighting parameters 11 are sufficient for calculation of the recognition value S.

In action 18, fulfillment of a recognition criterion is checked. In some embodiments, the recognition value S is compared against a threshold value S₀ and, if the threshold value S₀ is exceeded, the operator action is classified in action 19 as a valid operator action. Otherwise, the sensor values continue to be subjected to the target tracking routine via action 12 and monitored, in action 14, for fulfillment of the trigger criterion for the purpose of establishing a next check-time window 13.

It is conceivable for the recognition criterion to comprise further (partial) criteria in addition to the recognition value calculated in the check routine. In a further design, it is provided that, in the check routine, sensor values are fed as input values to a trained machine learning model, and that the recognition criterion relates to an output value of the trained machine learning model in addition to the recognition value, in some embodiments that the trained machine learning model is based on a support vector machine.

The machine learning model may be designed to reproduce the basic properties of the sensor arrangement 6. For example, the machine learning model is trained on a test setup with a comprehensive training data set. An individual setting of the operator action recognition for the respective installation situation, in particular the respective vehicle type, may be effected by way of the weighting parameters 11. Accordingly, it may even be sufficient for the comparatively complex training of the machine learning model to be effected just once.

The recognition criterion takes into consideration both the recognition value and at least one output value of the trained machine learning model. For example, respective necessary criteria are defined for the recognition value and the at least one output value. The recognition value and the at least one output value may also be weighted in relation to each other and compared against a threshold value.

It can be provided that the weighting parameters 11 are obtained by means of the control arrangement 7 via a communication network of the motor vehicle 2, in particular transmitted from a central motor-vehicle control system. Accordingly, the sensor arrangement 6 and the control arrangement 7 can be installed in different types of motor vehicle, the weighting parameters 11 being transmitted to the control arrangement 7 or queried by the control arrangement 7 for the purpose of individual setting of the operator action recognition.

If the trained machine learning model mentioned is used, it can be provided that the trained machine learning model is stored in the control arrangement 7.

In some embodiments, a plurality of sets of weighting parameters 11 are provided, with an operating mode being assigned to each of them. The sets of weighting parameters 11 may in turn be stored in the control arrangement 7 and/or obtained from the control arrangement 7. When one of the operating modes occurs, the set of weighting parameters 11 assigned to the respective operating mode is used in the check routine.

Consequently, the operator action detection can be easily adapted to the boundary conditions of the respective situation. The operating mode may be set or changed in that a predefined operating mode criterion is fulfilled by the sensor values. In this case, in addition to sensing the operator action, the sensor arrangement 6 may advantageously be designed to recognize particular operating conditions. An example of this is a person remaining at the sensor arrangement 6, for example when a person is sitting on the flap arrangement 1, during servicing, a cleaning process or the like.

The weighting parameters 11 may be adapted in such a way that, in comparison with a normal operating mode, the robustness of the operator action detection is increased. Also conceivable are operating modes in which an enhanced sensitivity of the operator action detection is implemented.

The operating mode may also be predefined for the control arrangement 7, for example, via a higher-level control device such as the central motor-vehicle control system. The control arrangement 7 may obtain an operating-mode signal. The operating-mode signal can also be realized by new weighting parameters 11 for the current operating mode being transmitted to the control arrangement 7.

Further, it can be provided that the weighting parameters 11 are determined in a parameterization routine based on predefined parameterization sensor values in accordance with a parameterization rule, in some embodiments that the weighting parameters 11 are determined using a parameterization rule based on linear regression.

The parameterization sensor values are created, for example, by a sequence of operator actions on a test setup for the respective vehicle type. In this case, an annotation may be effected for individual operator actions (valid/invalid or the like). The parameterization rule is generally a rule on how an optimal set of weighting parameters 11 is created from correspondingly annotated parameterization sensor values. In some embodiments, here is the use of a linear regression that allows particularly simple optimization, in particular in the case of weighting parameters 11 realized as linear coefficients.

Proposed according to a further teaching is a control arrangement 7 for a motorized flap arrangement 1 of a motor vehicle 2, the control arrangement 7, when in the mounted state, being coupled to a sensor arrangement 6 that senses sensor values relating to an operator action performed by an operator 8 outside of the motor vehicle 2, the control arrangement 7 checking the sensed sensor values in a check routine for the presence of a valid operator action, and the control arrangement 7 causing a drive arrangement 3 of the flap arrangement 1 to effect a motorized adjustment if a valid operator action is present.

It is provided in this case that the control arrangement 7 is configured to determine a predefined selection of statistical values from the sensor values in the check routine, to calculate a recognition value of the operator action from the determined statistical values using a predefined weighting function with respective weighting parameters 11 assigned to the statistical values, and to classify the operator action as a valid operator action if a recognition criterion is fulfilled by the recognition value.

Reference may be made to all explanations relating to the method according to the proposal.

Proposed according to a further teaching is a flap arrangement 1 for a motor vehicle 2, the flap arrangement 1 being configured to perform the method according to the proposal. Reference may be made to all explanations relating to the method according to the proposal and to the control arrangement 7 according to the proposal.

Further, it can be provided that the sensor arrangement 6 has at least one radar sensor 9, regarding which reference is also made to the above explanations.

1. A method for operating a motorized flap arrangement of a motor vehicle, a drive arrangement comprising at least one drive assigned to a flap, a sensor arrangement and a control arrangement coupled to the drive arrangement and to the sensor arrangement,
sensor values relating to an operator action performed by an operator outside of the motor vehicle being sensed by the sensor arrangement,
the sensed sensor values being checked by the control arrangement in a check routine for the presence of a valid operator action, and
the drive arrangement being caused by the control arrangement to effect a motorized adjustment if a valid operator action is present,
wherein a predefined selection of characteristic values is determined from the sensor values in the check routine, a recognition value of the operator action is calculated from the determined characteristic values using a predefined weighting function with respective weighting parameters assigned to the characteristic values, and the operator action is classified as a valid operator action if a recognition criterion is fulfilled by the recognition value.

2. The method as claimed in claim 1, wherein the weighting function is predefined as a linear function of the characteristic values with the weighting parameters as coefficients of the characteristic values.

3. The method as claimed in claim 1, wherein the predefined selection comprises characteristic values of distance values and/or velocity values from the sensor values, and/or the predefined selection comprises characteristic values of values derived from distance values and velocity values.

4. The method as claimed in claim 1, wherein the predefined selection comprises characteristic values of intensity values, angle values and/or noise values from the sensor values.

5. The method as claimed in claim 1, wherein a check-time window is established from the sensed sensor values by the control arrangement on the basis a trigger criterion, and the sensor values sensed in the check time period are subjected to the check routine.

6. The method as claimed in claim 1, wherein the characteristic values are redefined as statistical characteristic values.

7. The method as claimed in claim 1, wherein, in the check routine, sensor values are fed as input values to a trained machine learning model, and the recognition criterion relates to an output value of the trained machine learning model in addition to the recognition value.

8. The method as claimed in claim 1, wherein the weighting parameters are obtained by the control arrangement via a communication network of the motor vehicle.

9. The method as claimed in claim 1, wherein a plurality of sets of weighting parameters are provided, with an operating mode being assigned to each of them, when one of the operating modes occurs.

10. The method as claimed in claim 1, wherein the weighting parameters are determined in a parameterization routine based on predefined parameterization sensor values in accordance with a parameterization rule.

11. A control arrangement for a motorized flap arrangement of a motor vehicle, the control arrangement, when in the mounted state, being coupled to a sensor arrangement that senses sensor values relating to an operator action performed by an operator outside of the motor vehicle, the control arrangement checking the sensed sensor values in a check routine for the presence of a valid operator action, and the control arrangement causing a drive arrangement of the flap arrangement to effect a motorized adjustment if a valid operator action is present,
wherein the control arrangement is configured to determine a predefined selection of characteristic values from the sensor values in the check routine, to calculate a recognition value of the operator action from the determined characteristic values using a predefined weighting function with respective weighting parameters assigned to the characteristic values, and to classify the operator action as a valid operator action if a recognition criterion is fulfilled by the recognition value.

12. A flap arrangement for a motor vehicle, the flap arrangement being configured to perform the method as claimed in claim 1.

13. The flap arrangement as claimed in claim 12, wherein the sensor arrangement has at least one radar sensor.

14. The method as claimed in claim 1, wherein predefined selection comprises characteristic values of cross-correlation values derived from distance values and velocity values.

15. The method as claimed in claim 6, wherein the characteristic values of the selection comprise at least one of: maximum value, minimum value, time point of maximum value, time point of minimum value, mean value, variance, skewness, and/or kurtosis.

16. The method as claimed in claim 7, wherein the trained machine learning model is based on a support vector machine.

17. The method as claimed in claim 1, wherein the weighting parameters are obtained by the control arrangement via a communication network of the motor vehicle, transmitted from a central motor-vehicle control system.

18. The method as claimed in claim 8, wherein the trained machine learning model is stored in the control arrangement.

19. The method as claimed in claim 1, wherein a plurality of sets of weighting parameters are provided, with an operating mode being assigned to each of them, when one of the operating modes occurs, as a result of an operating-mode criterion being fulfilled by the sensor values and/or as a result of an operating-mode signal being obtained by the control arrangement, the set of weighting parameters assigned to the respective operating mode is used in the check routine.

20. The method as claimed in claim 10, wherein the recognition criterion is defined, at least partly, as a threshold value for the recognition value, and the weighting parameters are determined using a parameterization rule based on linear regression.
